(19) United States
(12) Patent Application Publication
(10) Pub. No.: US 2019/0132375 A1
(43) Pub. Date: May 2, 2019

(54) SYSTEMS AND METHODS FOR TRANSMITTING FILES ASSOCIATED WITH A VIRTUAL OBJECT TO A USER DEVICE BASED ON DIFFERENT CONDITIONS

(71) Applicant: Tsunami VR, Inc., Del Mar, CA (US)

(72) Inventors: Morgan Nicholas GEBBIE, Carlsbad, CA (US); Anthony DUCA, Carlsbad, CA (US)

(21) Appl. No.: 16/175,505

(22) Filed: Oct. 30, 2018

Related U.S. Application Data
(60) Provisional application No. 62/580,124, filed on Nov. 1, 2017.

(51) Int. Cl. H04L 29/06; G06T 15/20; H04L 29/08

(52) U.S. Cl. CPC H04L 65/602; G06T 15/20; G06T 19/006; H04L 67/06; G06T 2200/16; H04L 67/38

(57) ABSTRACT

Systems, methods, and computer readable media for managing files associated with a virtual object in a virtual environment are provided. The method can include receiving, at a server, a file including data related to the virtual object for transfer to a user device communicatively coupled to the server. The method can include determining, by the server, a maximum file size that the user device can receive. The method can include dividing the file into n different transmission files if a size of the file is greater than the maximum file size. The method can include transmitting the n different transmission files to the user device in a priority order based on viewpoint of the user device related to the virtual object.

### CROSS REFERENCE TO RELATED APPLICATIONS

This application claims priority to U.S. Provisional Patent Application Ser. No. 62/580,124, filed Nov. 1, 2017, entitled “SYSTEMS AND METHODS FOR TRANSMITTING FILES ASSOCIATED WITH A VIRTUAL OBJECT TO A USER DEVICE BASED ON DIFFERENT CONDITIONS,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology.

### SUMMARY

An aspect of the disclosure provides a method for managing files associated with a virtual object in a virtual environment. The method can include receiving, at a server, a file including data related to the virtual object for transfer to a user device communicatively coupled to the server. The method can include determining, by the server, a maximum file size that the user device can receive. The method can include dividing the file into n different transmission files if a size of the file is greater than the maximum file size. The method can include transmitting the n different transmission files to the user device in a priority order based on viewpoint of the user device related to the virtual object.

Another aspect of the disclosure provides a non-transitory computer-readable medium comprising instructions for a non-transitory computer-readable medium comprising instructions for managing files associated with a virtual object in a virtual environment. When executed by one or more processors the instructions cause the one or more processors to receive a file including data related to the virtual object for transfer to a user device communicatively coupled to the server. The instructions further cause the one or more processors to determine a maximum file size that the user device can receive. The instruction further cause the one or more processors to divide the file into n different transmission files if a size of the file is greater than the maximum file size. The instructions further cause the one or more processors to transmit the n different transmission files to the user device in a priority order based on viewpoint of the user device related to the virtual object.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a system for transmitting files associated with a virtual object to a user device;

FIG. 1B is a functional block diagram of another embodiment of a system for transmitting files associated with a virtual object to a user device;

FIG. 2A is a flowchart of an embodiment of a method for transmitting files associated with a virtual object to a user device based on one or more conditions;

FIG. 2B is a flowchart of another embodiment of a method for transmitting files associated with a virtual object to a user device based on one or more conditions;

FIG. 2C is a flowchart of another embodiment of a method for transmitting files associated with a virtual object to a user device based on one or more conditions;

FIG. 2D is a flowchart of another embodiment of a method for transmitting files associated with a virtual object to a user device based on one or more conditions;

FIG. 3 through FIG. 10 are graphical representations of embodiments of a process for transmitting files associated with a virtual object to a user device based on one or more conditions.

### DETAILED DESCRIPTION

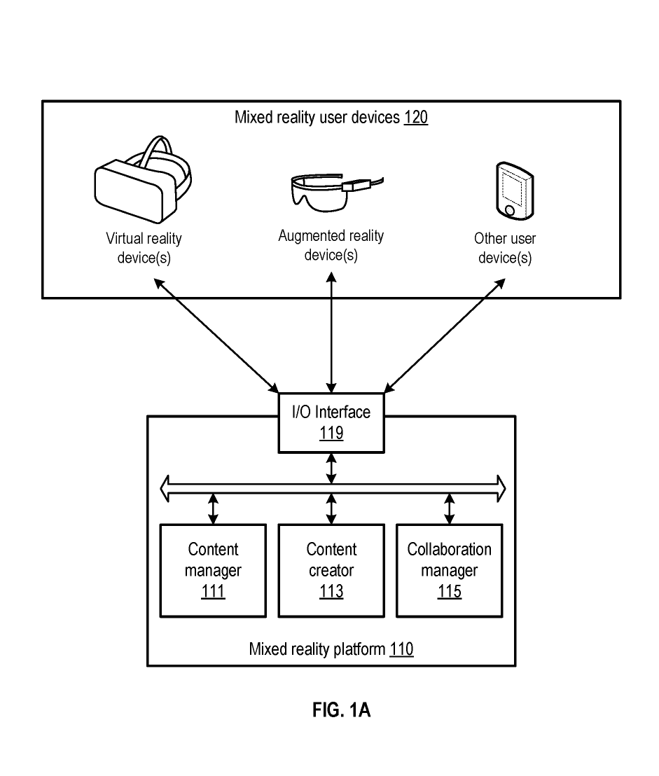

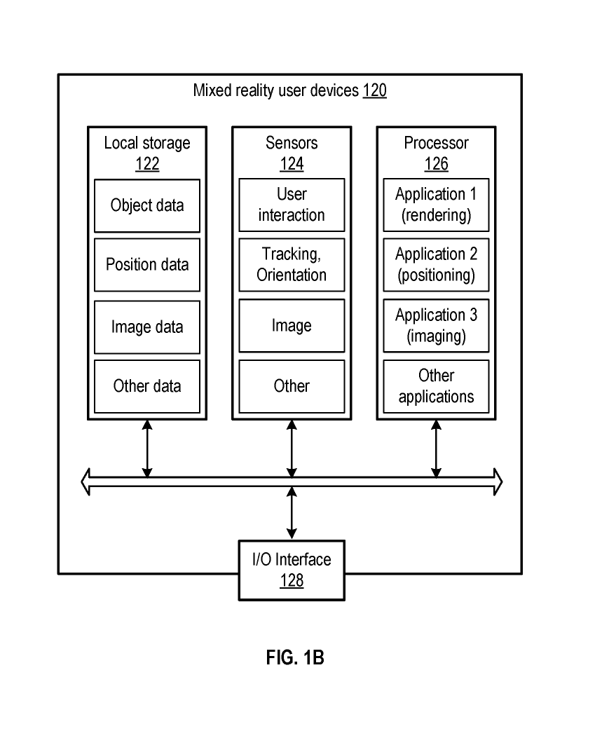

FIG. 1A and FIG. 1B are functional block diagrams of embodiments of a system for transmitting files associated with a virtual object to a user device. The transmitting can be based on different conditions. A system for creating computer-generated virtual environments and providing the virtual environments as an immersive experience for VR and AR users is shown in FIG. 1A. The system includes a mixed reality platform 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120. Such communications or transmissions can be enabled by a network (e.g., the Internet) or other communication link coupling the platform 110 and the user device(s) 120.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

This disclosure includes systems and methods for importing virtual objects of a virtual environment from the platform 110 to a user device 120 for display by that user device 120 to a user. In one embodiment, when a user device 120 makes a request to import a virtual object, the platform 110 receives the request, and separates the virtual object into smaller parts, sections, layers, versions or other things that can be sent to the user device 120 in available transport packets at a required or desired speed of transmission during a time period. After the transmission packets are received by the user device 120, the user device 120 (e.g., a client application running on a processor) reassembles the virtual object in different ways (e.g., in the background before rendering the virtual object in the user's viewing area, over time by rendering the content of each packet after that packet is received, or another way). By way of example, when a user selects a file to import to a user device 120, an application of the user device 120 sends a request to the platform 110 (e.g., the collaboration manager 115). The platform 110 locates the file and determines how to import the file based on the file type. If the file contains a virtual object (CAD, three-dimensional or other virtual object format), the platform 110 uses import tools to convert the virtual object into a common format for display if needed. The platform 110 then prepares the virtual object file for distribution to the requesting user device 120 and other user devices 120 that need to display the virtual object.

The platform 110 may have predefined rules for separating the virtual object depending on different conditions, and different conditions may apply to different user devices 120 such that the way a virtual object is separated for transmission to a first user device is different than the way the same virtual object is separated for transmission to a second user device. Examples of conditions include a maximum file size the user device 120 can receive in one transmission, the type of the user device 120, the connection speed between the platform 110 and the user device 120, permissions of a user operating the user device 120, or other conditions. For each user device 120, the platform 110 determines condition(s) that apply to that user device 120, and then looks up the rule controlling how the virtual object is separated for transmission to that user device 120. By way of example, the platform 110 may check the file size of the virtual object, determine a maximum file size a user device 120 can receive in a single transmission packet, determine if the file size of the virtual object is greater than the maximum file size, and either (i) transmit an unseparated version of the virtual object to the user device 120 when the file size of the virtual object is not greater than the maximum file size, or (ii) determine how to separate the virtual object for transmission to the user device 120.

The platform 110 may also check the connection quality and speed associated with the user device 120 to verify whether the virtual object can be transported in whole in a threshold amount of time. If the platform 110 determines the file can be sent in whole in the threshold amount of time, the platform 110 sends the entire file of the virtual object to that user device 120. Otherwise, the platform 110 determines how to separate the virtual object for transmission to that user device 120.

Different approaches for separating the virtual object are described herein. Each approach is configurable and can be adjusted based on desired user experience or other reasons.

One approach for separating the virtual object creates separate transmission files that each include one or more components of the virtual object (e.g., a different component or group of components such as wheels of a car). Each transmission file is created to be no greater than a maximum file size that a user device 120 can receive in a single transmission packet or during a threshold amount of time. When transmission files are sequentially transmitted, particular components of the virtual object may be prioritized over other components, and those prioritized components may be transmitted to and rendered for display on the user device 120 before the other components are transmitted to and rendered for display on the user device 120. Alternatively, all transmission files or a set of transmission files must be received by the user device 120 before the user device 120 assembles the contents of those files for rendering.

Another approach for separating the virtual object involves the platform 110 generating and sending multiple versions of the transmission files. For example, the platform 110 can send a lower quality version (e.g., coarser, less precise, less granular, less refined, less detailed or other simpler version) of the virtual object or component(s) thereof in one or more initial transmission(s) for rendering and display at the user device 120, and then later transmitting a higher quality version (e.g., less coarse, more precise, more granular, more refined, more detailed or other complex version) of the virtual object or component(s) thereof for rendering and display at the user device 120. If an amount of a file size occupied by a particular component of a virtual object exceeds a threshold amount (e.g., the maximum file size a user device 120 can receive in a single transmission, or a smaller value), then a lower quality version of that particular component is transmitted even though higher quality versions of other components are transmitted, and the user device 120 can render a version of the virtual object that includes both the lower quality version of that particular component and the higher quality versions of other components. After the user device 120 receives a higher quality version of the particular component that was previously received in lower quality, the user device 120 replaces the lower-quality version with the higher-quality version. As a result, the user can see the virtual object appearing to become more refined and detailed over time until the highest quality version of the virtual object that is available for the user is rendered.

Yet another approach for separating the virtual object involves separating the virtual object into slices (e.g., vertically, horizontally or combination thereof) or into layers from the outside of the object to the inside of the object, such that the slices or layers can be displayed in the order they are received by the user device 120.

Each approach for separating the virtual object described herein can be used to (i) receive all or a group of transmission files before rendering the combined content of those files, or (ii) render content of single transmission files as those files are received. Transmission files that include parts of a virtual object that meet a condition (e.g., the parts are not in the user's viewing area, are not of interest to the user, or another condition) may be transmitted after transmission files that include parts of a virtual object that do not meet the condition. In some cases, the transmission files that include parts of a virtual object that meet the condition are not transmitted or rendered until those parts no longer meet the condition. A user's interest in part of an object may be confirmed when the user's position in the virtual environment approaches the part of that object, or interacts with the part of that object by selecting, moving, attempting to “slice/dissect” the object, or other interaction.

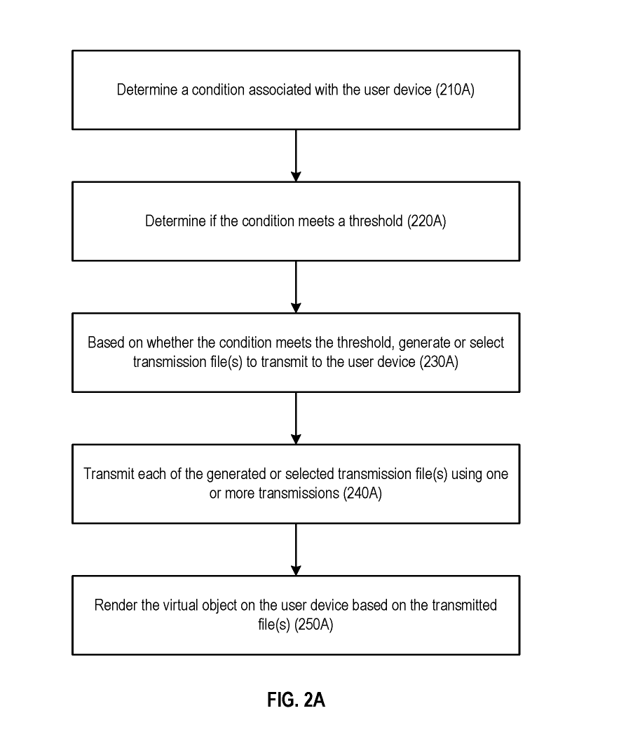

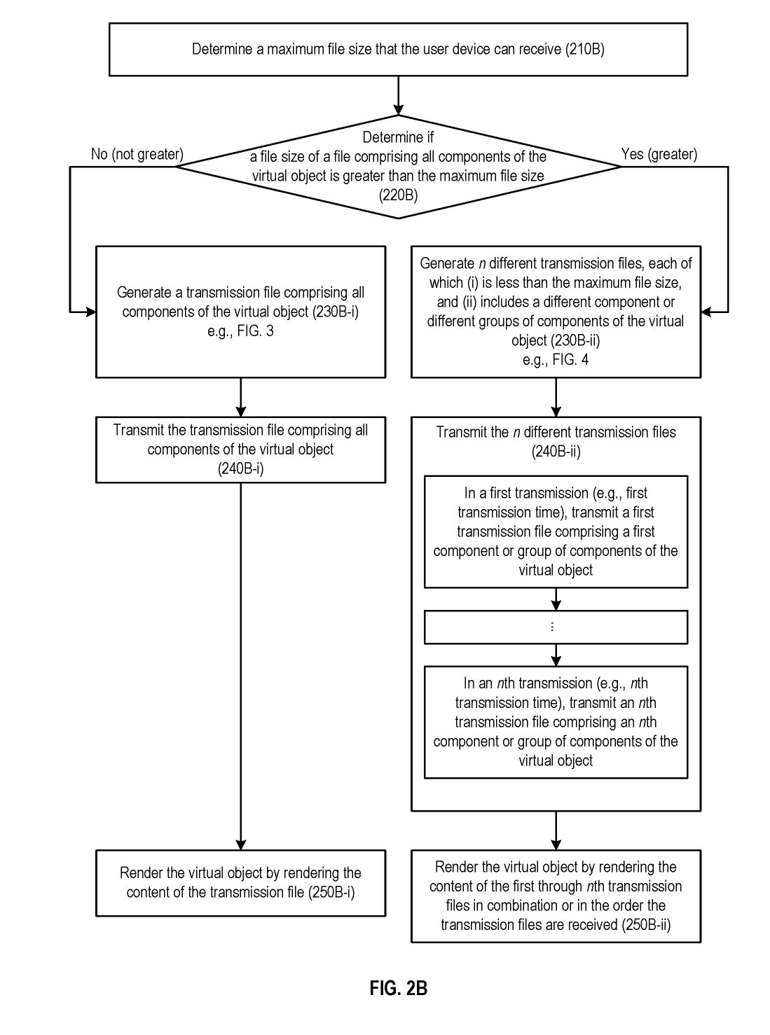

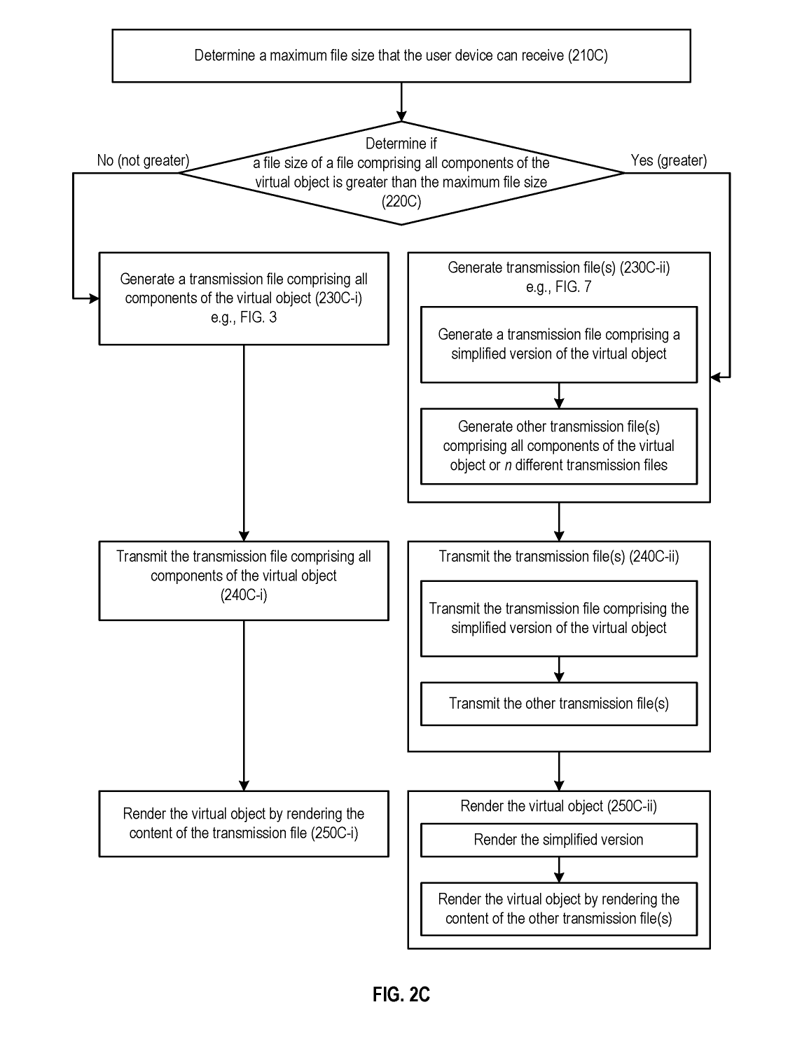

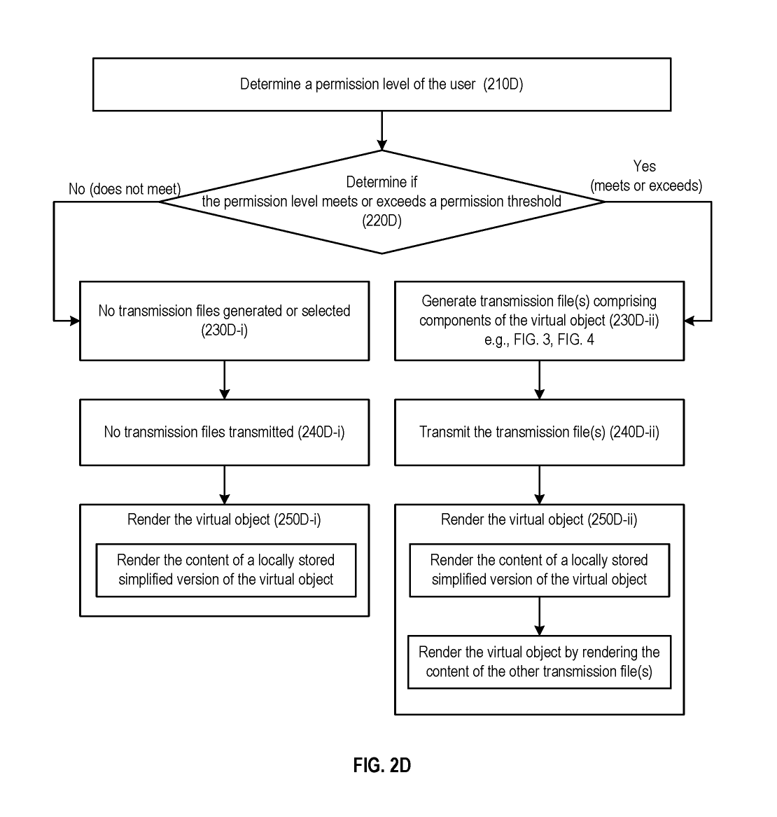

FIG. 2A through FIG. 2D, which are described below, each depict a different embodiment of a process for transmitting files associated with a virtual object to a user device based on one or more conditions. Conditions may be set by one or more of the platform 110, the user device 120 or the network or communication link connecting the platform 110 to the user device(s) 120. The methods or processes outlined and described herein and particularly those that follow below, can be performed by one or more processors of the platform 110, either alone or in connection with the user device(s) 120 via network or other communication connection. The processes can also be performed using distributed or cloud-based computing.

Transmitting Files Associated with a Virtual Object to a User Device Based on Different Conditions

FIG. 2A is a flowchart of a process for transmitting files associated with a virtual object to a user device based on one or more conditions. As shown, a condition associated with a user device is determined (210A) by, for example, the platform 110. As used herein, the conditions can be provided to the platform 110, requested from the user device 120 by the platform 110, and/or determined independently by the platform 110. In some embodiments, the platform 110 can determine or otherwise receive the indications of such conditions directly from the user device 120 via a direct message or a response to a request by the platform 110. In some other embodiments, the platform 110 can lookup conditions in a lookup table stored by the platform 110. Such conditions may be provisioned at the user device 120 and known a priori by the platform 110. The platform 110 can further independently determine conditions, by for example, a ping on a connection with the user device 120 to determine a network speed. Other conditions may include one or more known network restrictions (e.g., of a local network) that determine a maximum file size or transfer speed, for example.

The platform 110 can further determine whether condition meets a threshold (220A). For example, the condition can relate to the files associated with the virtual object or the user device. The files can be a collection or collections of data related to the components of a virtual object. The components can include parts or pieces of the virtual object. The figures use depict a car as a primary example, thus the components can be wheels, windows, engine parts, etc. A component as used herein can be any subpart or divisible part of the virtual object. Based on whether the condition meets the threshold, one or more transmission file(s) specifying parts of a virtual object are generated or selected (230A). The transmission file(s) are transmitted to the user device using one or more transmissions (240A), and the parts of the virtual object are rendered on the user device based on the transmitted file(s) (250A). Examples of conditions include a transmission capability of the user device (e.g., a maximum file size or a transmission time period), a permission level of the user, or another condition. Transmissions may be separated in time, by channel, or other communication technique.

Another process for transmitting files associated with a virtual object to a user device based on one or more conditions is shown in FIG. 2B. As shown, a maximum file size that the user device can receive is determined (210B). A determination is made as to whether a file size of a file comprising all components of the virtual object is greater than the maximum file size (220B).

If the file size of the file comprising all components of the virtual object is not greater than the maximum file size, a transmission file comprising all components of the virtual object is generated or selected (230B-i), the generated or selected transmission file is transmitted to the user device (240B-i), and the user device renders the virtual object by rendering the content of the transmitted transmission file (250B-i).

If the file size of the file comprising all components of the virtual object is greater than the maximum file size, n different transmission files are generated or selected, wherein each transmission file (i) is less than the maximum file size, and (ii) includes a different component or different groups of components of the virtual object (230B-ii). The n different transmission files are transmitted to the user device (240B-ii), and the user device renders the virtual object by rendering the content of the first through nth transmission files in combination, or in the order the transmission files are received (250B-ii). In some embodiments, n is an integer. During step 240B-ii, a first transmission file comprising a first component or group of components of the virtual object is transmitted in a first transmission (e.g., at a first transmission time), a second transmission file comprising a second component or group of components of the virtual object is transmitted in a second transmission (e.g., at a second transmission time), and so on until an nth transmission file comprising an nth component or group of components of the virtual object is filed in an nth transmission (e.g., at an nth transmission time), where n is greater than 1.

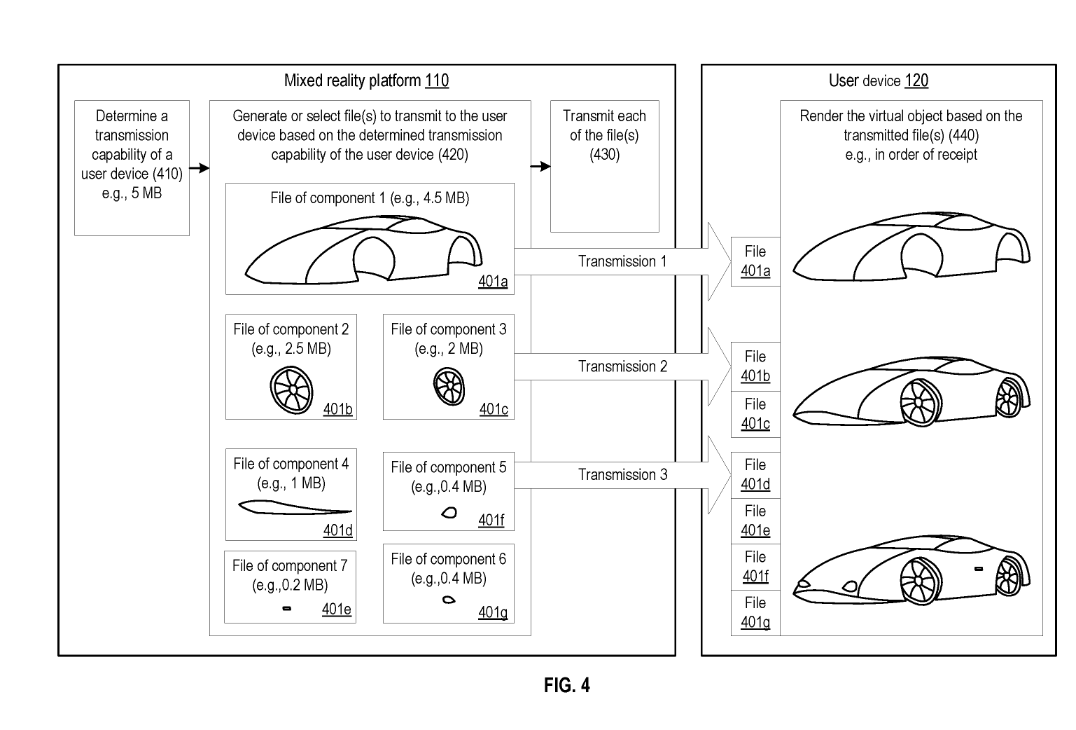

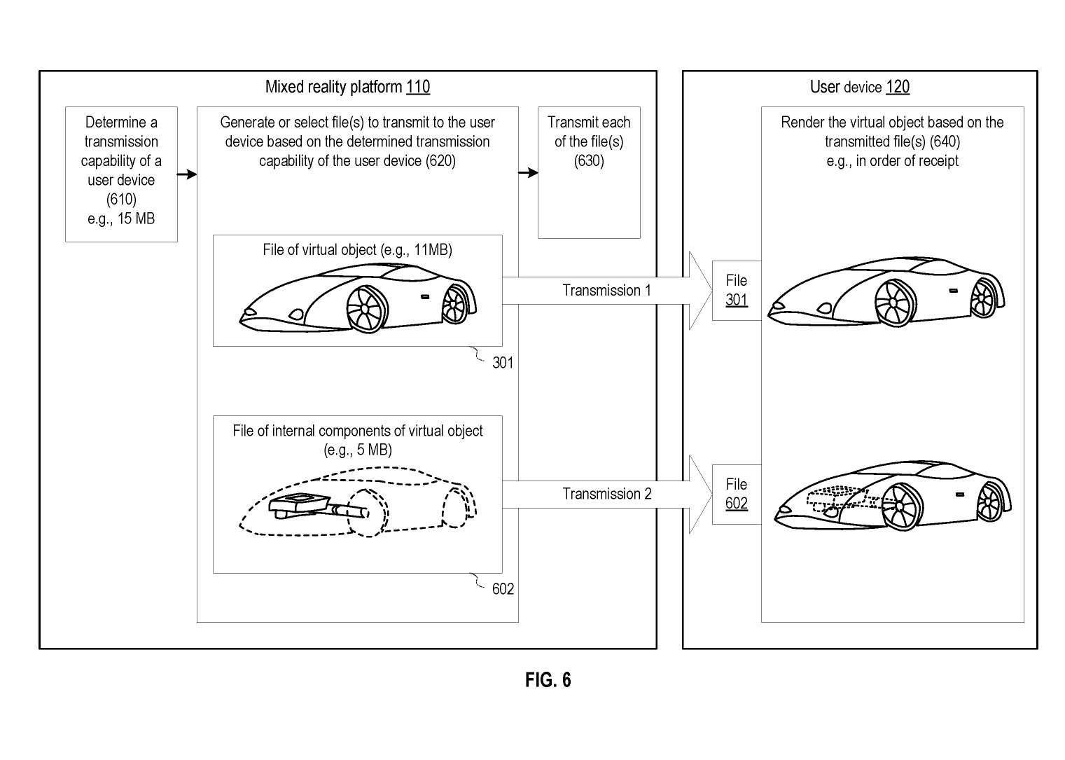

In an optional embodiment of FIG. 2B, a prioritized order of transmission during step 240B-ii is determined, and transmission files are transmitted in the prioritized order. Doing so would permit more important, prominent or other types of parts of the virtual object to be transmitted for display before other parts. By way of example, prioritized orders of parts and associated data or files are shown in FIG. 4 and FIG. 6. As described herein, priority for transmission of files (that describe parts or components of virtual objects) can be based on various characteristics. For example, transmission priority may be based on size of the files, portion or component of the virtual object that the files describe (e.g., outside has higher priority than inside), distance from the virtual object, or other criteria described herein.

The flow of FIG. 2B may also be used for different portions, slices, layers or other separated parts of a virtual object instead of components.

Another process for transmitting files associated with a virtual object to a user device based on one or more conditions is shown in FIG. 2C. As shown, a maximum file size that the user device can receive is determined (2100). A determination is made as to whether a file size of a file comprising all components of the virtual object is greater than the maximum file size (220C).

If the file size of the file comprising all components of the virtual object is not greater than the maximum file size, a transmission file comprising all components of the virtual object is generated or selected (2300-i), the transmission file is transmitted to the user device (2400-i), and the user device renders the virtual object by rendering the content of the transmission file (2500-i).

If the file size of the file comprising all components of the virtual object is greater than the maximum file size, one or more transmission files are generated or selected (2300-ii) and transmitted to the user device (2400-ii). The user device renders the virtual object by rendering the content of the transmission files in combination or in the order the transmission files are received (2500-ii). During step 2300-ii, an initial transmission file comprising a simplified (i.e., lower quality) version of the virtual object is generated or selected before n other transmission file(s) comprising a complex (i.e., higher quality) version of the virtual object are generated or selected. During step 2400-ii, the initial transmission file is transmitted to the user device before the n other transmission file(s) are transmitted to the user device. Finally, during step 2500-ii, content of the initial transmission file is rendered for display on the user device before content of the n other transmission file(s) are rendered for display on the user device.

By way of example, a simplified version of a virtual object may omit components of the virtual object, may include only portions of components, may include less resolution (e.g., less triangles or polygons) or texture or color than higher quality versions of the object, or other differences in features of the virtual object compared to higher quality, more complex versions.

Another process for transmitting files associated with a virtual object to a user device based on one or more conditions is shown in FIG. 2D. As shown, a permission level of the user is determined (210D). In one embodiment, different permission levels allow a user to receive different versions of a virtual object that have different levels of quality. A determination is made as to whether the permission level of the user meets or exceeds a permission threshold (220D).

If the permission level of the user does not meet or exceed the permission threshold, no transmission files are generated or selected (230D-i), or transmitted to the user device (240D-i). If a locally stored version of the virtual object (e.g., a lower quality version) exists at the user device, the locally stored version is rendered for display on the user device.

If the permission level of the user meets or exceeds the permission threshold, transmission file(s) comprising components of the virtual object are generated or selected (230D-ii), and the transmission files are transmitted to the user device (240D-ii). If a locally stored version of the virtual object (e.g., a lower quality version) exists at the user device, the locally stored version is rendered for display before the user device renders the content of the transmission files to display a different version of the virtual object (e.g., a higher quality version) the user is allowed to view (250D-ii).

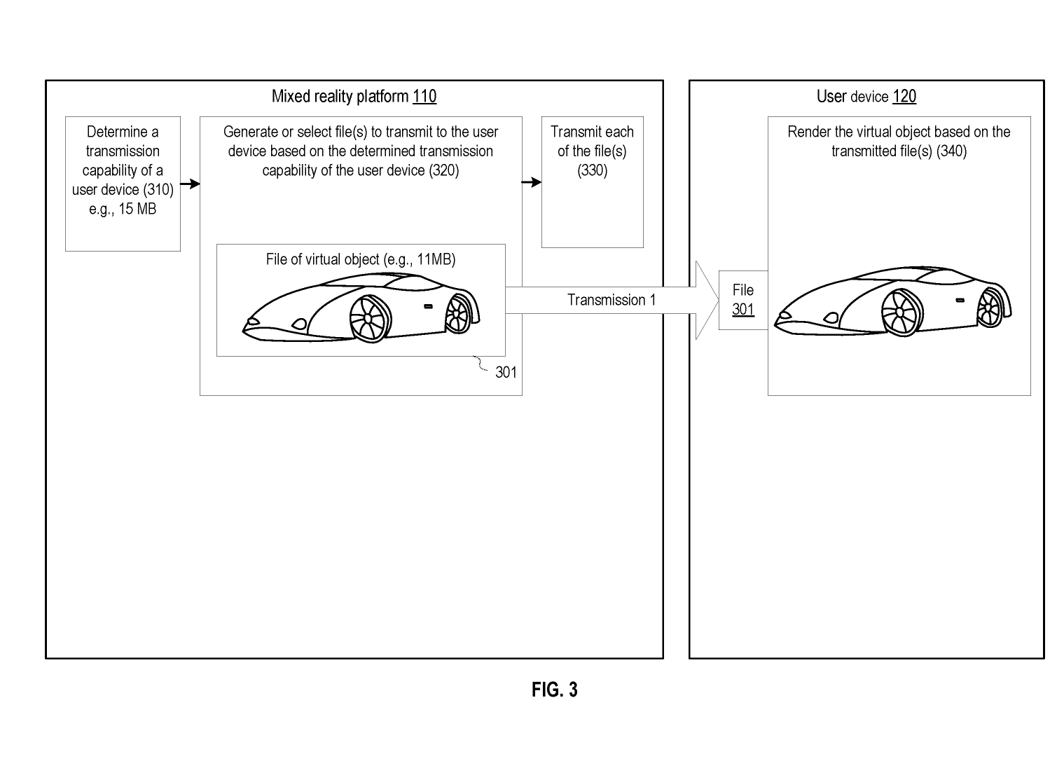

FIG. 3 through FIG. 10, which are described below, each provides an illustration of a different process for transmitting files associated with a virtual object to a user device based on one or more conditions.

FIG. 3 is a graphical representation of an embodiment of a process for transmitting files associated with a virtual object to a user device based on one or more conditions. As shown, the platform 110 determines a transmission capability of a user device 120 (310)—e.g., the user device is capable of received a maximum file size of 15 MB for each transmission packet, or can only receive a maximum file size of 15 MB during a transmission time period using the data transmission channel of the user device 120. The platform 110 generates or selects file(s) (e.g., file 301) to transmit to the user device 120 based on the determined transmission capability of the user device 120 (320), and the platform 110 transmits the generated or selected file(s) (330). As shown, the entire size of the virtual object is 11 MB, which is below the maximum size of 15 MB. The user device 120 receives the transmitted file(s) (e.g., the file 301), and renders the virtual object based on the transmitted file(s) (340).

FIG. 4 is a graphical representation of another embodiment of a process for transmitting files associated with a virtual object to a user device based on one or more conditions. As shown, the platform 110 determines a transmission capability of a user device 120 (410)—e.g., 5 MB. The platform 110 generates or selects file(s) (e.g., files 401a-g) to transmit to the user device 120 based on the determined transmission capability of the user device 120 (420), and the platform 110 transmits the generated or selected file(s) during different transmissions (430). As shown, different files containing different components of the virtual object are generated, where each file has a size that is below the transmission capability—e.g., a first file 401a is generated for a first component of the virtual object that has a size of 4.5 MB, second and third files 401b and 401c are generated for second and third components of the virtual object that have a combined size of 4.5 MB, and fourth through seventh files 401d through 401g are generated for fourth through seventh components of the virtual object that have a combined size of 20 MB. The first file 401a is transmitted during a first transmission, the second and third files 401b and 401c are transmitted during a second transmission, and the fourth through seventh files 401d through 401g are transmitted during a third transmission. As the user device 120 receives the transmitted file(s), the user device 120 renders the parts of the virtual object that are in each file (440).

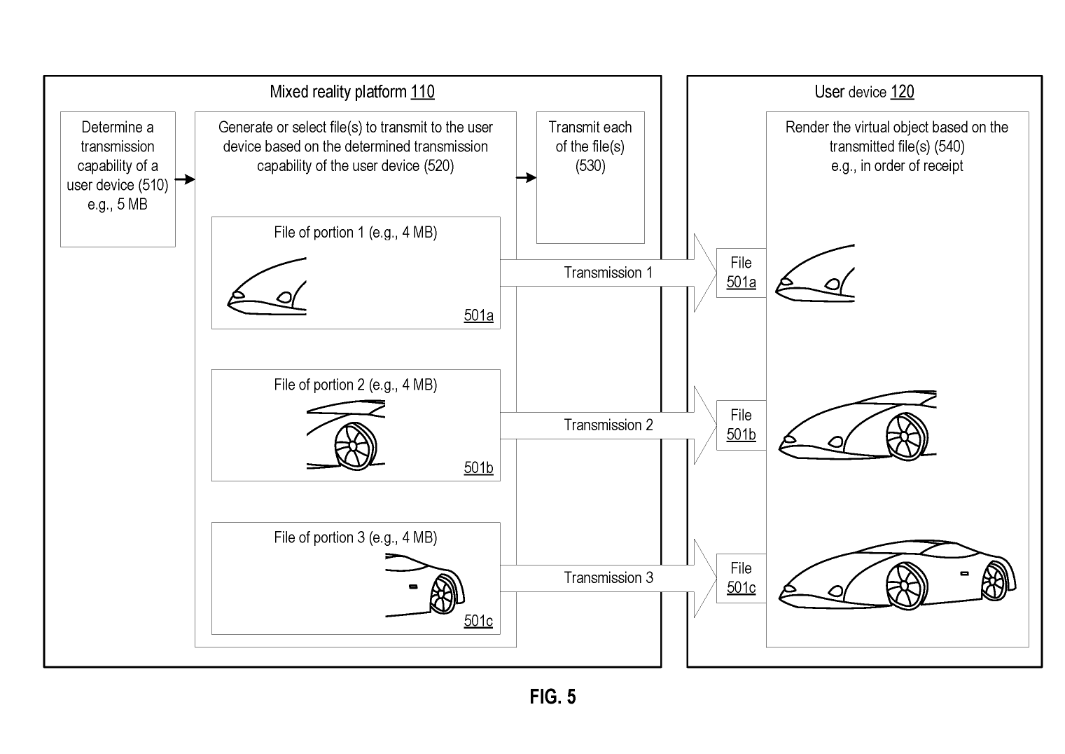

FIG. 5 is a graphical representation of another embodiment of a process for transmitting files associated with a virtual object to a user device based on one or more conditions. As shown, the platform 110 determines a transmission capability of a user device 120 (510)—e.g., 5 MB. The platform 110 generates or selects file(s) (e.g., files 501a-c) to transmit to the user device 120 based on the determined transmission capability of the user device 120 (520), and the platform 110 transmits the generated or selected file(s) during different transmissions (530). As shown, different files containing different portions of the virtual object are generated, where each file has a size that is below the transmission capability—e.g., first, second and third files 501a, 501b and 501c with file sizes less than the transmission capability are each generated for first, second and third portions of the virtual object, and transmitted during different transmissions. As the user device 120 receives the transmitted file(s), the user device 120 renders the portions of the virtual object that are in each file (540). In an alternative embodiment not shown in FIG. 5, all of the files 501a-c are received and combined before the virtual object is rendered.

FIG. 6 is a graphical representation of another embodiment of a process for transmitting files associated with a virtual object to a user device based on one or more conditions. As shown, the platform 110 determines a transmission capability of a user device 120 (610)—e.g., 15 MB. The platform 110 generates or selects file(s) (e.g., a first file 301 and a second file 602) to transmit to the user device 120 based on the determined transmission capability of the user device 120 (620), and the platform 110 transmits the generated or selected file(s) during different transmissions (630). As shown, different files containing different parts of the virtual object are generated, where each file has a size that is below the transmission capability. As the user device 120 receives the transmitted file(s), the user device 120 renders the parts of the virtual object that are in each file (640).

In some embodiments, the order (e.g., priority) in which files are sent can be based on the perspective or viewpoint/vantage point of the user. The process illustrated in FIG. 6 is useful for displaying outer parts of a virtual object that are in view of a user, and later rendering inner parts of the virtual object that are not yet in view of a user. If, on the other hand, the user needed to interact (e.g., view, modify, or other interaction) with the internal component of the second file 602, the second file 602 would be transmitted for display before the first file 301.

It is noted that the user of a VR/AR/XR system is not technically “inside” the virtual environment. However the phrase “perspective of the user” is intended to convey the view that the user would have (e.g., via the user device) were the user inside the virtual environment. This can also be the “perspective the avatar of the user” within the virtual environment. It can also be the view a user would see viewing the virtual environment via the user device.

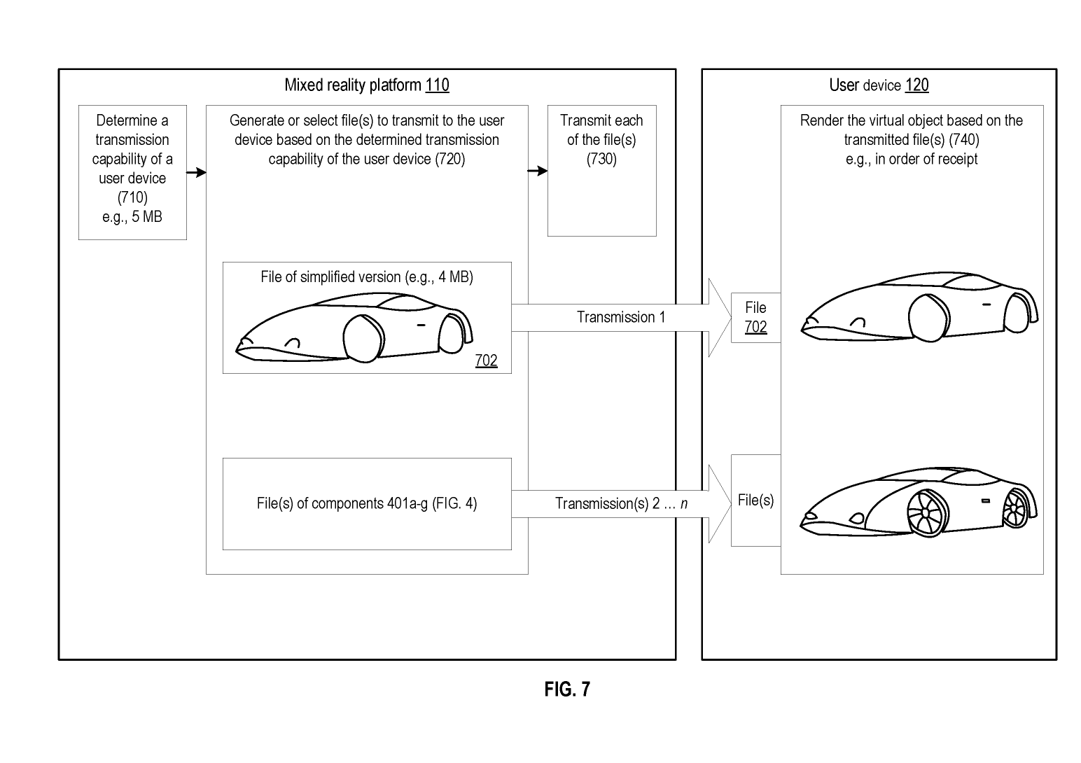

FIG. 7 is a graphical representation of another embodiment of a process for transmitting files associated with a virtual object to a user device based on one or more conditions. As shown, the platform 110 determines a transmission capability of a user device 120 (710)—e.g., 5 MB. The platform 110 generates or selects file(s) (e.g., an initial file 702 and other files from FIG. 4) to transmit to the user device 120 based on the determined transmission capability of the user device 120 (720), and the platform 110 transmits the generated or selected file(s) during different transmissions (730). As the user device 120 receives the transmitted file(s), the user device 120 renders the contents of each file (740). As shown, a simplified version of the virtual object stored in the initial file 702 is transmitted for display on the user device 120 before files containing more complex versions of the virtual object are transmitted for display on the user device 120. The process illustrated in FIG. 7 is useful when the file size of the complex version of the virtual object is significantly larger than the transmission capability, which would extend the time needed for the user to see general features of the virtual object.

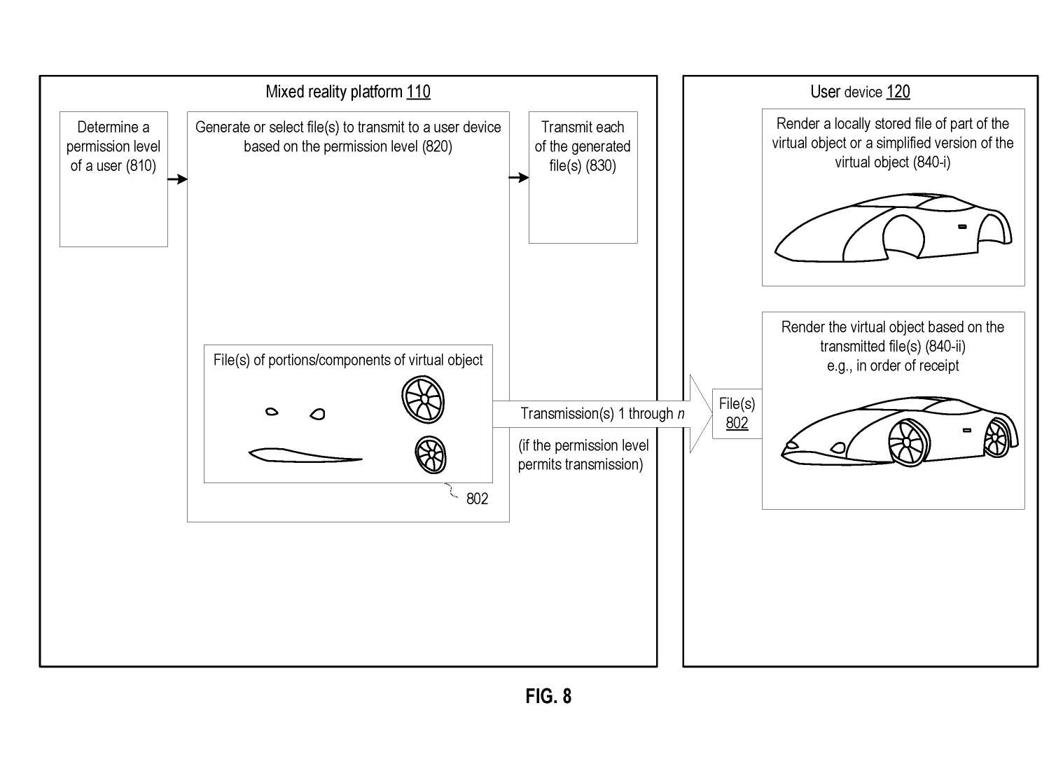

FIG. 8 is a graphical representation of another embodiment of a process for transmitting files associated with a virtual object to a user device based on one or more conditions. As shown, the platform 110 determines a permission level of a user (810), generates or selects file(s) (e.g., file(s) 802) to transmit to the user device 120 based on the determined permission level (820), and transmits the generated or selected file(s) during different transmissions if the permission level permits the transmissions (830). The user device 120 may already have a locally stored file of a part of the virtual object or a simplified version of the virtual object that is rendered (840-i). As the user device 120 receives the transmitted file(s), the user device 120 renders the contents of each file (840-ii). The process illustrated in FIG. 8 is useful when the locally stored file includes less important, less secure, or widely-accessible parts of the virtual object compared to the parts of the virtual object that are transmitted based on permission level status of a user. Permitting local storage of parts reduces the time needed to import and render the virtual object while also restricting access to particular parts of a virtual object to authorized users.

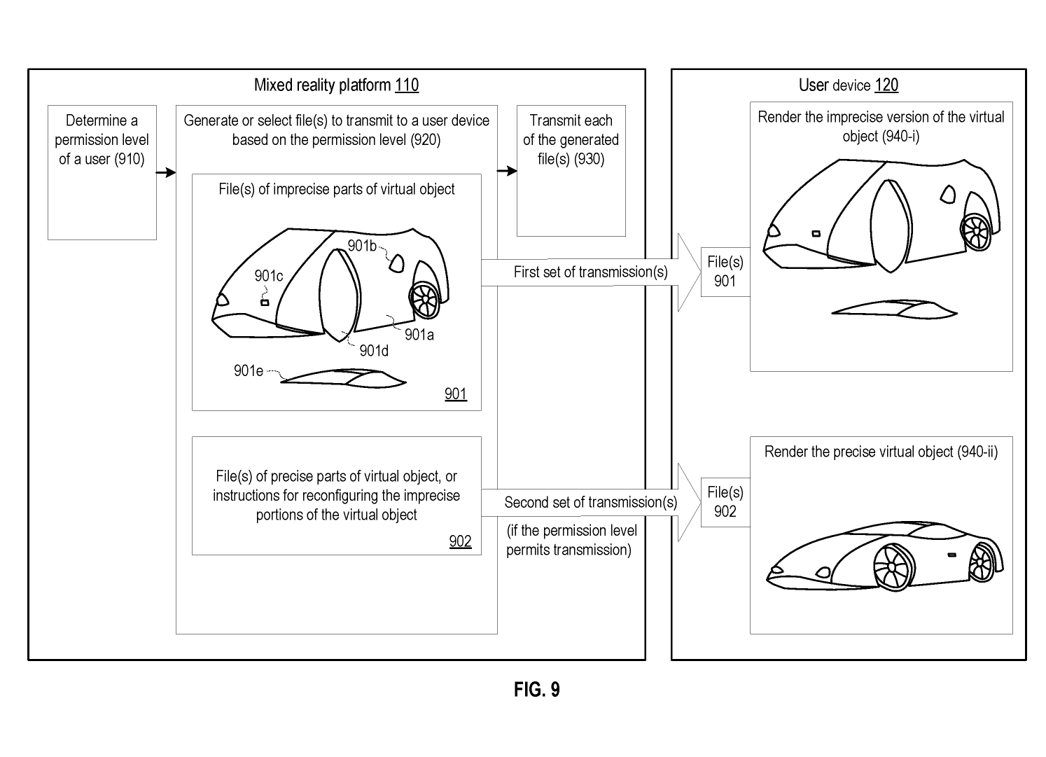

FIG. 9 is a graphical representation of another embodiment of a process for transmitting files associated with a virtual object to a user device based on one or more conditions. As shown, the platform 110 determines a permission level of a user (910), generates or selects file(s) (e.g., file(s) 901) to transmit to the user device 120 based on the determined permission level (920), and transmits the generated or selected file(s) during different transmissions if the permission level permits the transmissions (930). As the user device 120 receives the transmitted file(s), the user device 120 renders the contents of each file (940-i and 940-ii). In some embodiments, the first file 901 of imprecise parts of a virtual object may be made available to many user devices, but the file 902 of precise parts of the virtual object or instructions for reconfiguring the imprecise portions of the virtual object may be made available to selected user devices operated by users with particular permission levels. By way of example, imprecise versions of a virtual object may include a portion 901a of the virtual object that is not proportionally drawn to the actual scale of the virtual object, components 901b and 901c occupying switched locations, a portion 901d of the virtual object that has been omitted, a portion 901e of the virtual object that has been separated from the virtual object, a portion with a color or texture that is different than the true color or texture of that portion, a portion draw with less resolution (e.g., drawn with less triangles, polygons, or pixels), or another imprecise feature. Different advantages are achieved by providing imprecise versions, or partial versions of virtual objects. A first advantage is reduction of bandwidth, where less data needs to be transmitted to the user device. A second advantage is security, where certain features of a virtual object are made available to a user device while more other features of a virtual object are made available to the user only if the user has a certain permission level.

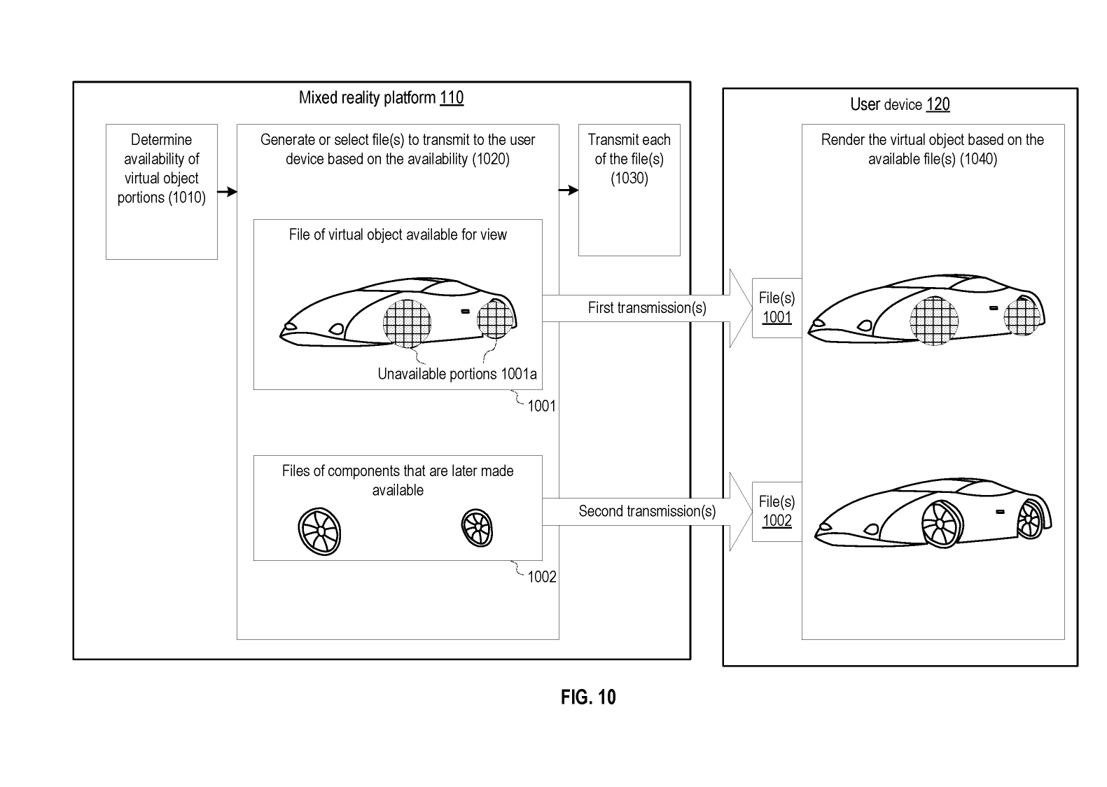

FIG. 10 is a graphical representation of another embodiment of a process for transmitting files associated with a virtual object to a user device based on one or more conditions. As shown, the platform 110 determines the availability of particular portions of a virtual object (1010), generates or selects file(s) (e.g., file(s) 1001 and 1002) to transmit to the user device 120 based on the determined availability (1020), and transmits the generated or selected file(s) during different transmissions depending on the availability (1030). As the user device 120 receives the transmitted file(s), the user device 120 renders the parts of the virtual object as they are available (1040). The process illustrated in FIG. 10 permits certain users to interact (e.g., create, modify, move, or other interaction) with particular portions of virtual objects (e.g., the portions in the second file 1002) before those portions and results of the interactions are made available to another user.

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for managing files associated with a virtual object in a virtual environment, the method comprising:
receiving, at a server, a file including data related to the virtual object for transfer to a user device communicatively coupled to the server;
determining, by the server, a maximum file size that the user device can receive;
if a size of the file is greater than the maximum file size, dividing the file into n different transmission files; and
transmitting the n different transmission files to the user device in a priority order based on viewpoint of the user device related to the virtual object.

2. The method of claim 1 further comprising determining the priority order based on a perspective of the user device viewing the virtual object, wherein components of the virtual object in view of the user on the user device have higher priority than components of the virtual object not in view.

3. The method of claim 1 further comprising dividing the file into n different transmission files based on one of:
components of the virtual object;
layers of the virtual object from outside the virtual object to inside the virtual object;
a plurality of horizontal slices; and
a plurality of vertical slices.

4. The method of claim 1 further comprising transmitting multiple versions of the n different transmission files to the user device, the multiple versions comprising a lower quality version followed by a higher quality version.

5. The method of claim 1, wherein each transmission file of the n different transmission files comprises less than the maximum file size.

6. The method of claim 1, wherein each transmission file of the n different transmission files comprises a different component of the virtual object.

7. The method of claim 1 further comprising generating, by the server, a transmission file including the data related to all components of the virtual object if a size of the file is less than the maximum file size.

8. The method of claim 1 further comprising:
determining a permission level associated the user device; and
transmitting the n different transmission files to the user device if the permission level is greater than a permission threshold.

9. The method of claim 8 further comprising:
transmitting imprecise versions of the n different files to the user device based on a first permission level; and
transmitting precise versions of the n different files to the user device based on a second permission level higher than the first permission level.

10. A non-transitory computer-readable medium comprising instructions for managing files associated with a virtual object in a virtual environment that when executed by one or more processors cause the one or more processors to:
receive a file including data related to the virtual object for transfer to a user device communicatively coupled to the server;
determine a maximum file size that the user device can receive;
if a size of the file is greater than the maximum file size, divide the file into n different transmission files; and
transmit the n different transmission files to the user device in a priority order based on viewpoint of the user device related to the virtual object.

11. The non-transitory computer-readable medium of claim 10 further comprising instructions to cause the one or more processors to determine the priority order based on a perspective of the user device viewing the virtual object, wherein components of the virtual object in view of the user on the user device have higher priority than components of the virtual object not in view.

12. The non-transitory computer-readable medium of claim 10 further comprising instructions to cause the one or more processors to divide the file into n different transmission files based on one of:
components of the virtual object;
layers of the virtual object from outside the virtual object to inside the virtual object;
a plurality of horizontal slices; and
a plurality of vertical slices.

13. The non-transitory computer-readable medium of claim 10 further comprising instructions to cause the one or more processors to transmit multiple versions of the n different transmission files to the user device, the multiple versions comprising a lower quality version followed by a higher quality version.

14. The non-transitory computer-readable medium of claim 10, wherein each transmission file of the n different transmission files comprises less than the maximum file size.

15. The non-transitory computer-readable medium of claim 10, wherein each transmission file of the n different transmission files comprises a different component of the virtual object.

16. The non-transitory computer-readable medium of claim 10 further comprising instructions to cause the one or more processors to generate a transmission file including the data related to all components of the virtual object if a size of the file is less than the maximum file size.

17. The non-transitory computer-readable medium of claim 10 further comprising instructions to cause the one or more processors to:
determine a permission level associated the user device; and
transmit the n different transmission files to the user device if the permission level is greater than a permission threshold.

18. The non-transitory computer-readable medium of claim 17 further comprising instructions to cause the one or more processors to:
transmit imprecise versions of the n different files to the user device based on a first permission level; and
transmit precise versions of then different files to the user device based on a second permission level higher than the first permission level.
